(19) United States
(12) Patent Application Publication
(10) Pub. No.: US 2003/0055557 A1
(43) Pub. Date: Mar. 20, 2003

(54) Method of calibrating a car alarm depending on the crime statistics of an area VIA intergration with road navigation display systems

(75) Inventors: Rabindranath Dutta, Austin, TX (US); Michael A. Paolini, Round Rock, TX (US)

Correspondence Address: BRACEWELL & PATTERSON, L.L.P., P.O. BOX 969, AUSTIN, TX, 78767-0969, US

(73) Assignee: International Business Machines Corporation, Armonk, NY

(21) Appl. No.: 09/956,774

(22) Filed: Sep. 20, 2001

(51) Int. Cl. G01C 21/30

(52) U.S. Cl. 701/208; 701/211

(57) ABSTRACT

A method, system, and computer program product are provided to selectively configure a security system based on geographically indexed incident statistics. The preferred embodiment involves a security unit for monitoring events indicative of threats to the security of a vehicle and a navigation unit that is able to ascertain the location of the vehicle. The navigation unit delivers data, indicative of the location of the vehicle, to the security unit. The security unit then uses the location data to acquire data regarding the statistical incidence of crime in the vicinity of the vehicle's location. Based on the data regarding the statistical incidence of crime in the vicinity of the vehicle's location, the appropriate configuration of the security unit is determined. The security unit then compares its current configuration to the appropriate configuration and selectively configures itself to match the appropriate configuration.

### BACKGROUND OF THE INVENTION

1. Technical Field:

The present invention relates in general to security systems and in particular to methods and systems for configuring security systems. Still more particularly, the present invention relates to methods and systems for selectively configuring a security system based on geographically indexed incident statistics.

2. Description of the Related Art:

Mobility, the very attribute that makes automobiles and similar transportation systems so useful, also makes such transportation systems popular targets for thieves. Within a few short minutes of breaking into an automobile, a thief can take the vehicle miles away in any direction, delivering the vehicle to any point where it can be sold, cut into parts for resale, or used in the commission of a crime. Automobile owners have always hoped for a remedy that will end the nightmare of vehicles lost to theft, and the automobile and electronics industries have worked with very limited success in developing effective theft deterrent systems. While innovative technological solutions should have seriously deterred theft, secondary effects of the technology have limited their effectiveness and the willingness of users to properly employ them.

A rapid increase in the rate of automobile theft in the last quarter of the twentieth century created a demand for improved methods of protecting vehicles. Fortunately, a concurrent revolution in portable consumer electronics technology occurred, and the electronics industry responded by developing and marketing security units that, when attached to a vehicle and armed, react to sensor data that indicates a potential threat to the security of the vehicle. A vast array of products offers a wide range of options in responding to a variety of stimuli. Typical events detected by security unit sensors include penetration of the vehicle's physical perimeter, breaking of glass, attempts to activate the engine of the vehicle, the presence of persons within a set distance from the vehicle, and the application of physical force to the vehicle's exterior. Sensors range from microphones to infra-red proximity and motion detectors, as well as conventional switches that can detect the opening of a door. Responses range from disabling the engine of the vehicle to a simulated voice advising persons to step away from the vehicle. The most common feature used to alert the owner of an automobile to a potential problem became the audible siren, sometimes able to be heard by persons standing several hundred yards away from the vehicle. Initially, the activation of an alert siren on an automobile attracted tremendous attention to the vehicle and the persons standing near it.

It briefly appeared that the technology would successfully deter the theft of vehicles equipped with security units, but problems developed. Users, intent on simply moving the car a short distance, forget to disable the security unit before activating the ignition and soon discovered that the ignition was disabled or an audible alarm was triggered. Security systems designed to respond to the application of physical force to a vehicle responded to the low-frequency sound emission from jet aircraft, large-block automobile engines, or planned, innocuous explosions in the vicinity of the vehicle. Sensors designed to detect the sound of broken glass responded instead to the sound of music played loudly in nearby vehicles. As vehicles carrying security units proliferated, the ubiquitous sound of needlessly activated alarms began to annoy the population at large. From the neighbor awakened from sleep in the small hours of the night to the attendees at a funeral who were disturbed by the sound of an alarm system reacting to a jet plane overhead, people grew intolerant of the constant whine of audible alarms attached to security units.

The problem of inappropriately activated alarms runs deeper than mere annoyance. As the sound of audible alarms grew ubiquitous, people became so desensitized to the sound as to be willing to ignore it. Like the boy who cried wolf, no one took seriously the whining of an alarm in a parking lot, and thieves soon learned that, even if an alarm were tripped, persons within earshot would assume a false alarm and would not bother to investigate. Alarms soon lost most of their usefulness as devices that would attract the attention of nearby persons. Worse still, people began frequently disabling their security units in order to prevent the disturbance of their neighbors. People with loud interior speakers attached to their alarms began to disable them to prevent their own annoyance. Any hope for the use of security units as an effective deterrent to the theft of automobiles was lost.

The electronics industry soon responded with more configurable security units, but the process of configuration proved too complicated for the average user, and was frequently forgotten, and involved more guesswork than systematic assessment of the risks from which a automobile required protection at any given location. Once again, a promising technology failed to deliver substantial deterrent results, and users continued to hope for improved security systems.

### SUMMARY OF THE INVENTION

It is therefore one object of the present invention to provide an improved security system.

It is another object of the present invention to provide an improved method and system for configuring security systems.

It is yet another object of the present invention to provide a method and system for selectively configuring a security system based on geographically indexed incident statistics.

The foregoing objects are achieved as is now described. A method, system, and computer program product are provided to selectively configure a security system on the basis of geographically indexed incident statistics. The preferred embodiment involves a security unit for monitoring events indicative of threats to the security of a vehicle and a navigation unit that is able to ascertain the location of the vehicle. The navigation unit delivers location data, indicative of the location of the vehicle, to the security unit. The security unit then uses the location data to acquire data regarding the statistical incidence of crime in the vicinity of the vehicle's location. Based on the data regarding the statistical incidence of crime in the vicinity of the vehicle's location, the appropriate configuration of the security unit is determined. The configuration will include enabling and setting the sensitivity of different types of sensors to trigger alarms of selectively varied frequency and severity on the basis of the relative frequency of certain crimes near the location of the vehicle. The security unit then compares its current configuration to the appropriate configuration and selectively configures itself to match the appropriate configuration.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, and further objects and advantages thereof, will best be understood by reference to the following detailed description of an illustrative embodiment when read in conjunction with the accompanying drawings, wherein:

FIG. 1 depicts a wireless vehicular communications environment for the communication of navigation and security data to a navigation unit and a security unit, respectively, in which a preferred embodiment of the present invention may be implemented;

FIG. 2 is an interlinked system of radio-frequency-enabled vehicular navigation and security units in accordance with a preferred embodiment of the present invention;

FIG. 3 depicts a high-level flowchart of a method for selectively configuring a security unit based on geographically indexed incident statistics in accordance with a preferred embodiment of the present invention;

FIG. 4 depicts a message flow timing diagram for the transmission of messages between functional modules of a method for selectively configuring a security unit based on geographically indexed incident statistics in accordance with a preferred embodiment of the present invention; and

FIG. 5 is a high-level flowchart of a method for selectively configuring a security unit based on geographically indexed incident statistics in accordance with an alternative embodiment of the present invention.

### DETAILED DESCRIPTION OF THE PREFERRED EMBODIMENT

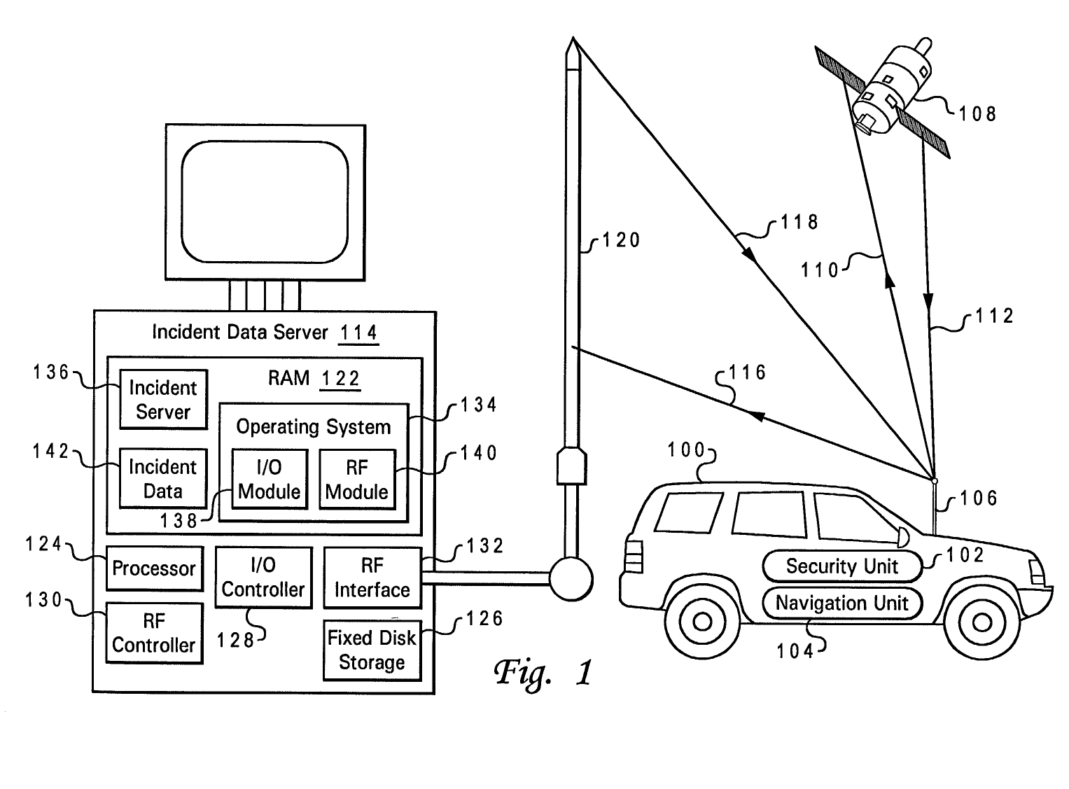

With reference now to the figures, and in particular with reference to FIG. 1, a wireless vehicular communications environment for the communication of navigation and security data to a navigation unit and a security unit, respectively, in which a preferred embodiment of the present invention may be implemented, is illustrated. The figure includes a vehicle 100, containing a security unit 102 and a navigation unit 104. The vehicle 100 also contains a mobile radio-frequency communication system 106, which is used by the navigation unit 104 to communicate with a radio-frequency-based position location system 108. Typical examples of a radio-frequency-based position location system 108 include the Global Positioning System (GPS), in which a request 110 for a location data signal 112 is sent from the navigation unit 104, by means of the mobile radio-frequency communication system 106, to the radio-frequency-based position location system 108, in this case a group of satellites in orbit above the earth. The radio-frequency-based position location system 108 then replies to the request 110 by sending a location data signal 112 to the mobile radio-frequency communication system 106. While the radio-frequency-based position location system 108 of the preferred embodiment involves the use of a satellite in earth orbit, a radio-frequency-based position location system 108 employing stationary radio-communications towers could also be employed without departing from the spirit and scope of the present invention. A vast variety of additional means could be used to inform the navigation unit 104 of the location of the vehicle 100 without departing from the scope and spirit of the present invention.

The security unit 102 of the preferred embodiment also employs the mobile radio-frequency communication system 106 to communicate with an incident data server 114, though some alternative embodiments will not require this functionality and will store incident statistics within the security unit 102. A request 116 for an incident occurrence data item 118 is sent from the security unit 102, by means of the radio-frequency communication system 106, to the incident data server 114, in this case a data processing system attached to a stationary radio-frequency communication system 120. The incident data server 114 then replies to the request 116 by sending an incident occurrence data item 118 to the mobile radio-frequency communication system 106. The mobile radio-frequency communication system 106 relays the incident occurrence data item 118 to the security unit 102. As depicted in the preferred embodiment, the security unit 102 and the navigation unit 104 share a common radio-frequency communication system 106, though this arrangement is suggested merely for purposes of a simplified example and is not intended to limit the scope of the invention. The invention could be used in a configuration wherein the security unit 102 and the navigation unit 104 employ separate, dedicated radio-frequency communication systems.

The security unit 102 is an automated system designed to prevent and deter theft of the vehicle 100. It operates by selectively responding to external stimuli that may indicate threats to the security of the vehicle 100. These events are detected through the use of sensors, which range from microphones to infra-red proximity and motion detectors, as well as conventional switches that could detect the opening of a door. Typical events detected by security unit sensors include penetration of the physical perimeter of the vehicle 100, breaking of glass, attempts to activate the engine of the vehicle 100, the presence of persons within a set distance from the vehicle 100, and the application of physical force to the exterior of the vehicle 100. The security unit 102 may be selectively configured to respond to one or more of these events. A response to the detection of a potential threat can be selectively configured to include the activation of an audible siren, disabling of the engine of the vehicle 100, or an audible warning to persons near the vehicle 100 that they should step away from the vehicle 100. Other functions of the security unit 102 will typically include locking or unlocking of car doors and activating the ignition of the engine of the vehicle 100. Other, less typical functions of the security unit 102 may also be included without departing from the scope and spirit of the invention.

The figure also shows a simplified schematic representation of the parts of a incident data server 114, which could be used in support of the preferred embodiment of the present invention. A typical incident data server 114 will resemble a general-purpose data processing system containing a random access memory (RAM) unit 122, a processor 124, a fixed-disk storage unit 126, an input and output (I/O) controller 128, a radio frequency (RF) controller 130, and an RF interface 132. The RAM unit 122 serves as a short term storage location for data and instructions as the processor 124 operates on the data and instructions. In the preferred embodiment of the present invention, the RAM unit 122 is shown as containing multiple programs and a data structure. The programs include an operating system 134 and an incident server 136. Though only those two programs are shown in the RAM unit 122 of the preferred embodiment, many additional programs, which are omitted for the sake of simplicity and clarity, may also run on the incident data server 114 without departing from the scope or spirit of the present invention. The operating system 134 controls program execution, resource allocation, input/output operations, and other functions of the data processing system. It exists as a series of modules, only two of which are shown for the sake of simplicity. The I/O module 138 controls the instructions sent to the I/O controller 128 while the RF module 140 controls the operation of the RF interface 132 and the RF controller 130. The other program shown as stored in the RAM unit 122, the incident server 136, provides the incident data item 118 requested by the security unit 102. The incident server 136 generates the incident data item 118 from the incident data 142, which is also stored within the RAM unit 122.

Other components of the incident data server 114, whose functions have not yet been explained, will typically include a fixed-disk storage unit 126, an I/O controller 128, an RF controller 130, and an RF interface 132. The fixed-disk storage unit 126 serves as a long term storage location for data and instructions. The I/O controller 128 provides an interface for most peripheral equipment while the RF controller 130 directs the operation of the RF interface 132, and the RF interface 132 provides physical connectivity to the stationary radio-frequency communication system 120.

The preferred embodiment involves the practice of the invention in the environment of an automobile or other self-propelled vehicle 100, though it is worth noting that the invention also applies equally to security systems attached to any object, including fixed objects such as homes. In embodiments attached to fixed objects, radio links may be replaced by fixed communication links, or both incident and location data may be supplied by attachment of storage media or through user input. Location and incident data may also be supplied on the basis of user input or other means in alternative embodiments of the invention that are used on mobile vehicles.

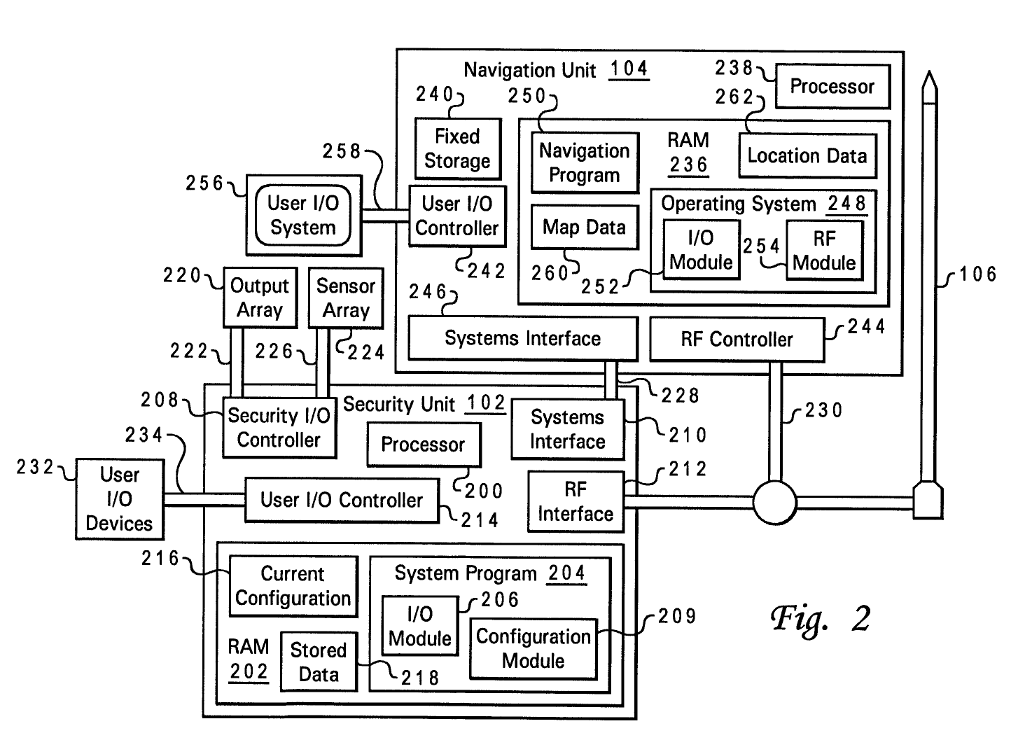

With reference to FIG. 2, an interlinked system of radio-frequency-enabled vehicular navigation and security units in accordance with a preferred embodiment of the present invention is depicted. The diagram shows in greater detail the security unit 102 and navigation unit 104, as well as the connection of these two devices to the mobile radio-frequency communication system 106. The security unit 102 and navigation unit 104 of the preferred embodiment, shown in very high-level schematic representations for the sake of simplicity, are merely exemplary and many different designs of security unit 102 and navigation unit 104 can be substituted without departing from the spirit and scope of the invention. In the preferred embodiment, the security unit 102 is a programmable system which operates on the basis of instructions executed by a processor 200. It also contains a RAM unit 202, which serves as a short term storage location for data and instructions as the processor 200 operates on the data and instructions.

In the preferred embodiment of the present invention, the RAM unit 202 is shown as containing a system program 204 and multiple data structures. The system program 204 contains logic and instructions for performing the functions required of the security unit 102 and operating the various components of the security unit 102. It exists as a series of modules, only two of which are shown for the sake of simplicity. The I/O module 206 controls the instructions sent to the security I/O controller 208, while the configuration module 209 controls the operation of the systems interface 210, the RF interface 212, and the user I/O controller 214. The data structures stored in the RAM unit 202 include the current configuration 216, which contains selectively configurable setting information that dictates the responses of the security unit 102 to external stimuli, and the stored data 218. The stored data 218 can contain information ranging from a record of sensory stimuli to a stored geographic database of incident occurrence statistics.

Other components of the security unit 102, whose functions have not yet been explained, will typically include a security I/O controller 208, a systems interface 210, an RF interface 212, and a user I/O controller 214. The security I/O controller 208 provides physical connectivity to an output array 220 across an output interface 222 and provides connectivity to a sensor array 224 across an input interface 226. In addition to the physical connectivity, the security I/O controller 208 translates commands from the processor 200 into a format usable to the output array 220 and translates sensory input from the sensor array 224 into a format usable to the processor 200. The sensor array will typically include sensor switches to detect penetration of the physical perimeter of the vehicle 100 by means of opening a door, microphones designed to detect breaking of glass, an ignition continuity sensor to detect attempts to activate the engine of the vehicle 100, infra-red sensors to detect the presence of persons or movement within a set distance from the vehicle 100, and shock sensors to detect the application of physical force to the exterior of the vehicle 100. The output array 220 will typically include an audible siren for attracting attention to the vehicle, a voice synthesizer and speaker for communicating with persons inside of or outside of the vehicle, an ignition kill switch for disabling the vehicle, remote switches to control the vehicle's door locks, remote switches to activate the vehicle's lights, and remote switches to control the vehicle's horn.

The systems interface 210 provides physical and logical connectivity between the security unit 102 and the navigation unit 104 by means of an inter-system connector 228. The systems interface 210 enables communication between the two units and facilitates transmission of location information from the navigation unit 102 to the security unit 104. The RF interface 212 provides physical and logical connectivity between the security unit 102 and the mobile radio-frequency communication system 106 across the RF adapter 230. This arrangement enables the security unit to communicate with the incident data server 114 and to receive an incident occurrence data item 118 from the incident data server 114. The user I/O controller 214 provides physical connectivity to user I/O devices 232 across a user I/O interface 234. User I/O devices 232 may include physical switches, touch pads, transceivers for communication with remote control equipment, and a variety of display systems. In addition to the physical connectivity, the user I/O controller 214 translates commands from the processor 200 into a format usable to user I/O devices 232 and translates sensory input from the user I/O devices 232 into a format usable to the processor 200.

The navigation unit 104, provides location data to the security unit 102 in the preferred embodiment of the present invention. A typical navigation unit 104 will resemble a special-purpose data processing system containing a random access memory (RAM) unit 236, a processor 238, a fixed storage unit 240, a user I/O controller 242, an RF controller 244, and a systems interface 246. The RAM unit 236 serves as a short term storage location for data and instructions as the processor 238 operates on the data and instructions. In the preferred embodiment of the present invention, the RAM unit 236 is shown as containing multiple programs and multiple data structures. The programs include an operating system 248 and a navigation program 250. Though only those two programs are shown in the RAM unit 236 of the preferred embodiment, many additional programs, which are omitted for the sake of simplicity and clarity, may also run on the navigation unit 104 without departing from the scope or spirit of the present invention. The data structures shown as being stored in the RAM unit include map data 260 and location data 262. The map data is used to plot routes and is displayed to the user, while the location data 262, indicative of the current position of the navigation unit 104, is used to plot routes and is provided to the security unit 102. The operating system 248 controls program execution, resource allocation, input/output operations, and other functions of the navigation unit 104. It exists as a series of modules, only two of which are shown for the sake of simplicity. The I/O module 252 controls the instructions sent to the user I/O controller 242, systems interface 246, and fixed storage 240, while the RF module 254 controls the operation of the RF controller 244. The other program shown as stored in the RAM unit 236, the navigation program 250, provides location data requested by the security unit 102 and also provides general-purpose user interface and navigation functions. Fixed storage 240 provides a storage location for additional navigational data, such as maps not currently in use by the navigation unit 104.

Other components of the navigation unit 104, whose functions have not yet been explained, will typically include a systems interface 246, an RF controller 244, and a user I/O controller 242. The systems interface 246 provides physical and logical connectivity between the security unit 102 and the navigation unit 104 by means of an inter-system connector 228. The systems interface 246 enables communication between the two units and facilitates transmission of location information from the navigation unit 102 to the security unit 104. The RF controller 244 provides physical and logical connectivity between the navigation unit 104 and the mobile radio-frequency communication system 106 across the RF adapter 230. This arrangement enables the navigation unit to communicate with the radio-frequency-based position location system 108 and to receive a location data signal 112 from the radio-frequency-based position location system 108. The user I/O controller 242 provides physical connectivity to the user I/O system 256 across a user I/O interface 258. The user I/O system 256 may include physical switches, touch pads, display screens, speakers, and microphones. In addition to the physical connectivity, the user I/O controller 242 translates commands from the processor 238 into a format usable to user I/O system 256 and translates sensory input from the user I/O system 256 into a format usable to the processor 238.

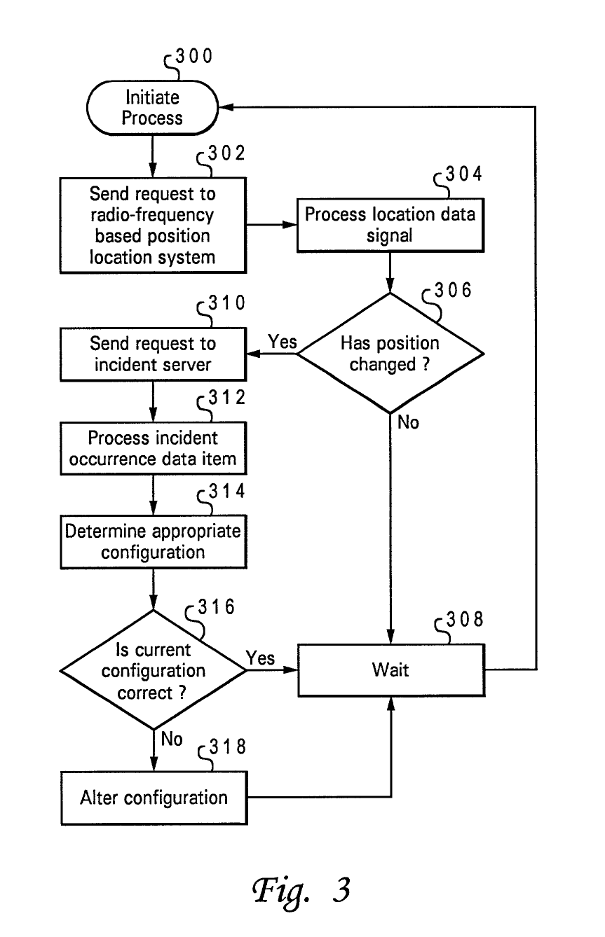

With reference to FIG. 3, a high-level flowchart of a method for selectively configuring a security unit based on geographically indexed incident statistics in accordance with a preferred embodiment of the present invention is illustrated. The process begins at step 300, which depicts the process being initiated. In the preferred embodiment of the invention, the process will be triggered by a counter in the system program 204 of the security unit 102. The system program 204 will contain a clock routine in the configuration module 209 that will count cycles of the processor 200. After a sufficient number of processor cycles, a flag will be raised in the system program 204 that will cause the initiation of the process. After initiation, the process next passes to step 302, which illustrates sending a request 110 for a location data signal 112 to the radio-frequency based position location system 108. The process then proceeds to step 304, which depicts navigation unit 104 and the security unit 102 processing a location data signal 112. The process next passes to step 306, which illustrates the security unit 102 determining whether the location of the vehicle 100 has changed. If the location of the vehicle 100 has not changed sufficiently to warrant a request 116 for an incident occurrence data item 118, the process then proceeds to step 308, which depicts the security unit 102 waiting before re-initiating the process. The system program 204 will contain a clock routine in the configuration module 208 that will count cycles of the processor 200. After a sufficient number of processor cycles, a flag will be raised in the system program 204 that will cause the initiation of the process by means of the process returning to step 300.

If the location of the vehicle 100 has changed sufficiently to warrant a request 116 for an incident occurrence data item 118, the process next passes to step 310, which illustrates the security unit 102 sending a request 116 for an incident occurrence data item 118 to the incident data server 114, which will typically be a physically separate data processing system, either within the vehicle or outside the vehicle in the preferred embodiment, but may be a logical process on the security unit 102 in some alternative embodiments. The size of an incident occurrence data item 118 will vary widely from one implementation of the preferred embodiment to another. In some embodiments, where large incident occurrence data items represent the incident occurrence data for large areas of territory, an intermediate step may be imposed wherein the security unit 102 compares the location of the vehicle to a stored geographic database of incident occurrence data in the stored data 218 and, if the vehicle has not moved out of the area covered by the stored geographic database in the stored data 218, the security unit derives an appropriate configuration from the stored geographic database in the stored data 218 rather than sending a request 116 for an incident occurrence data item 118 to the incident data server 114.

However, in the preferred embodiment, after sending a request 116 for an incident occurrence data item 118 to the incident data server 114, the process then proceeds to step 312, which depicts the navigation unit 104 and the security unit 102 processing an incident occurrence data item 118 from the incident data server 114. The process next passes to step 314, which illustrates the security unit 102 determining the appropriate configuration of the security unit 102. Determining the appropriate configuration of the security unit 102 is done by comparing the statistical data in the incident occurrence data item 118 to a listing of actions appropriate to certain statistical toggles for certain types of incident. For every type of incident that is included in the incident occurrence data item 118, the security unit will compare the relative frequency of the event to one or more toggle values that trigger one or more configuration settings in the security system. For instance, the incident occurrence data item 118, may include a relative frequency of common car theft equal to a value X. The security unit 102 will compare the relative frequency of common car theft to a toggle value for car theft, Y. If the toggle value for common car theft exceeds the relative frequency of common car theft in the vehicle's current geographic location, then the a less sensitive security configuration is determined to be appropriate. If the relative frequency of common car theft in the vehicle's current geographic location exceeds the toggle value for common car theft, then the a more sensitive security configuration is determined to be appropriate.

The system may discover from analysis of the incident occurrence data item 118 that incidents, which are likely to threaten the security of the vehicle, are unlikely at the vehicle's current geographic location. For example, in the environment of a corporate campus or military base, where crime is substantially deterred by the presence of security forces, the security unit 102 may determine that the appropriate configuration of the security unit 102 might include completely disabling sensors that detect the presence of persons within a set distance from the vehicle, disabling relays that automatically lock the doors of the vehicle when the engine is started, and reducing the sensitivity of sensors that detect the application of force to the vehicle's exterior while maintaining the sensitivity of sensors that detect penetration of the vehicle's physical perimeter, breaking of glass, and attempts to activate the engine of the vehicle. The effect would be to decrease the number of possible events that would trigger an alarm. In the counter-example of an area where the armed theft of automobiles from their drivers is common, the security unit 102 may determine that the appropriate configuration of the security unit 102 might include setting sensors that detect the presence of persons within a set distance from the vehicle to maximum sensitivity, enabling relays that automatically lock the doors of the vehicle when the engine is started, and increasing the sensitivity of sensors that detect the application of force to the vehicle's exterior while maintaining the sensitivity of sensors that detect penetration of the vehicle's physical perimeter, breaking of glass, and attempts to activate the engine of the vehicle. The effect would be to increase the number of possible events that would trigger an alarm.

Alternatively, in a stationary unit, such as one installed in a home, the security unit 102 may determine that the appropriate configuration of the security unit 102 in a high-crime area might include setting sensors that detect the presence of persons within a set distance from the home to maximum sensitivity and enabling circuits that automatically phone the police whenever the doors of the home are opened. The effect would be to increase the number of possible events that would trigger an alarm and to increase the severity of a response to a stimulus. In a low-crime area, the configuration of the same security unit 102 might include setting sensors that detect the presence of persons within a set distance from the home to minimum sensitivity and disabling circuits that automatically phone the police whenever the doors of the home are opened. The configuration might leave in place instructions to sound a small audible alarm whenever a door is opened. The effect would be to decrease the number of possible events that would trigger an alarm and to decrease the severity of a response to a stimulus.

The process then proceeds to step 316, which depicts the security unit 102 determining whether the security unit 102 is correctly configured. This is done by comparing the current configuration 216 of the security unit 102 to the configuration determined to be appropriate on the basis of the incident data item 118 in step 314. If the security unit 102 determines that the current configuration 216 is still appropriate, the process then proceeds to step 308, which depicts the security unit 102 waiting before re-initiating the process. The system program 204 will contain a clock routine in the configuration module 208 that will count cycles of the processor 200. After a sufficient number of processor cycles, a flag will be raised in the system program 204 that will cause the initiation of the process by means of the process returning to step 300. If the security unit 102 determines that the current configuration 216 is not appropriate, the process next passes to step 318, which depicts the security unit 102 altering its configuration. The security unit 102 may automatically alter its configuration or may seek user ratification before doing so, using the user I/O devices 232 to present the proposed revisions of the configuration and to accept user input as to whether to proceed with the alteration. The security unit 102 may also present to the user the actual incident occurrence statistics for the geographic area in which the vehicle is located, or may summarize them.

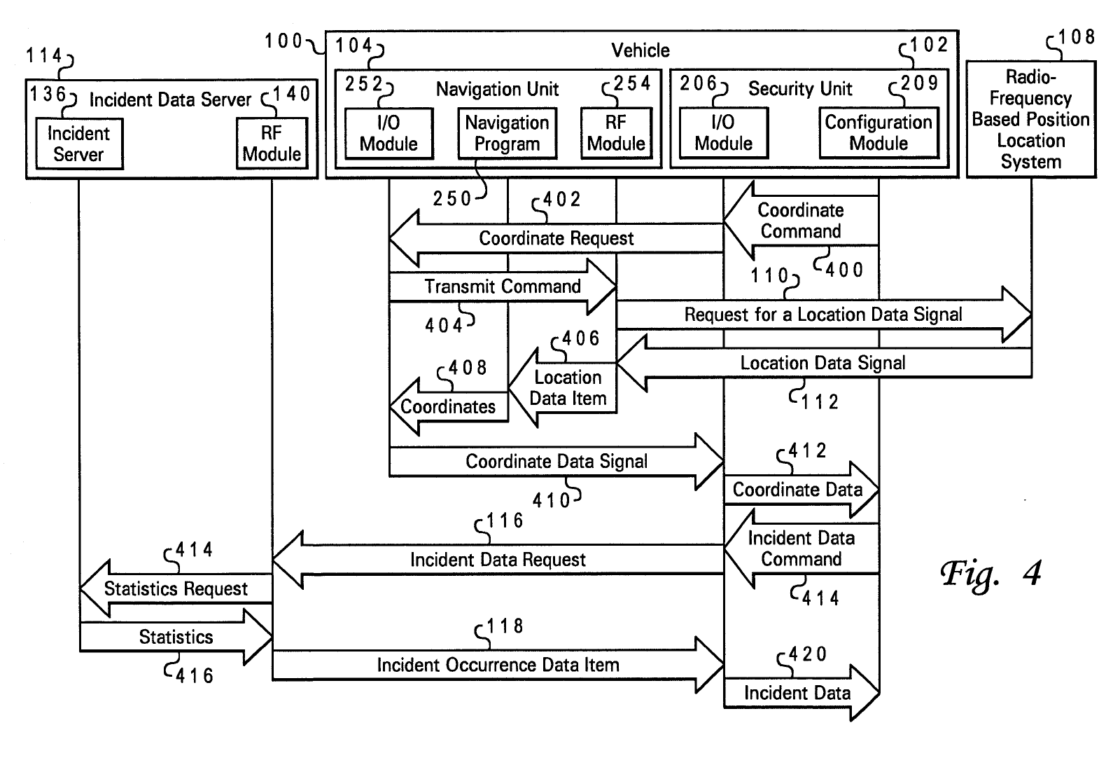

With reference to FIG. 4, a message flow timing diagram for the transmission of messages between functional modules of a method for selectively configuring a security unit based on geographically indexed incident statistics in accordance with a preferred embodiment of the present invention is illustrated. Because the message flow timing diagram serves principally to clarify the interaction between the logical components of the preferred embodiment and the components of the wireless vehicular communications environment in performing the process of selectively configuring a security unit based on geographically indexed incident statistics, it is best understood with reference to the high-level flowchart of FIG. 3. In step 302, which illustrates sending a request 110 for a location data signal 112 to the radio-frequency based position location system 108, several interactions between software modules are involved. Initially, the configuration module 209 of the security unit 102 sends a coordinate command 400 to the I/O module 206 of the security unit 102. The I/O module 206 of the security unit 102 then sends a coordinate request 402 to the I/O module 252 of the navigation unit 104. Responsive to receipt of the coordinate request 402 at the I/O module 252 of the navigation unit 104, the I/O module 252 of the navigation unit 104 sends a transmit command 404 to the RF module 254 of the navigation unit 104. The RF module 254 of the navigation unit 104 then sends a request 110 for a location data signal 112 to the radio-frequency based position location system 108.

The radio-frequency based position location system 108 will then typically reply to the request 110 for a location data signal 112 by sending a location data signal 112 to the RF module 254 of the navigation unit 104. Responsive to receipt of the location data signal 112 by the RF module 254 of the navigation unit 104, step 304 will begin as the RF module 254 sends a location data item 406 to the navigation program 250 of the navigation unit 104. The navigation program 250 will process the location data item 406 and will produce coordinates 408, which it will send to the I/O module 252 of the navigation unit 104. The I/O module 252 of the navigation unit 104 will then package the coordinates into a coordinate data signal 410, which it will send to the I/O module 206 of the security unit 104. The I/O module 206 of the security unit will then send coordinate data 412 to the configuration module 209 of the security unit 102.

The security unit 102 then determines whether the location of the vehicle 100 has changed in step 306. If the location of the vehicle 100 has changed sufficiently to warrant a request 116 for an incident occurrence data item 118, then the security unit will request incident occurrence data in step 310. This is accomplished in a series of steps, with the process being initiated by the configuration module 209 in the security unit 102 sending to the I/O module 206 of the security unit 102 an incident data command 414. Responsive to receipt of the incident data command 414, the I/O module 206 of the security unit 102 sends an incident data request 116 to the RF module 140 of the incident data server 114. Responsive to the incident data request 116 from the security unit 102, the RF module 140 of the incident data server 114 sends a statistics request 414 to the incident server module 136 of the incident data server 114. The incident server module 136 then sends statistics 416, indicative of relative frequency of relevant crimes, to the RF module 140. The RF module 140 then repackages the data from the statistics 416 into an incident occurrence data item 118 that the RF module 140 then sends to the I/O module 206 of the security unit 102. The I/O module 206 of the security unit 102 then takes the incident data 420 from the incident occurrence data item 118 and sends the incident data 420 to the configuration module in step 312.

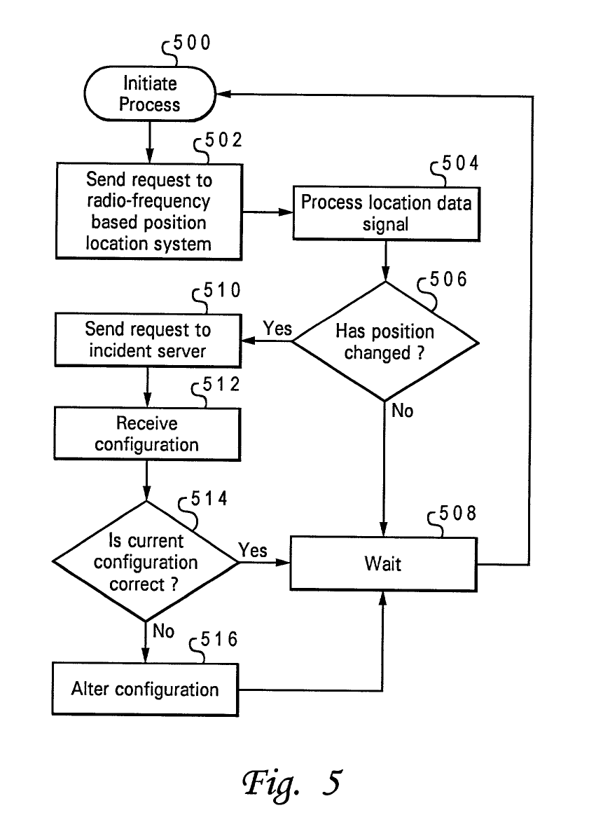

With reference to FIG. 5, a high-level flowchart of a method for selectively configuring a security unit based on geographically indexed incident statistics in accordance with an alternative embodiment of the present invention is depicted. The process begins at step 500, which depicts the process being initiated. In this alternative embodiment of the invention, the process will be triggered by a counter in the system program 204 of the security unit 102. The system program 204 will contain a clock routine in the configuration module 209 that will count cycles of the processor 200. After a sufficient number of processor cycles, a flag will be raised in the system program 204 that will cause the initiation of the process. After initiation, the process next passes to step 502, which illustrates sending a request 110 for a location data signal 112 to the radio-frequency based position location system 108. The process then proceeds to step 504, which depicts navigation unit 104 and the security unit 102 processing a location data signal 112. The process next passes to step 506, which illustrates the security unit 102 determining whether the location of the vehicle 100 has changed. If the location of the vehicle 100 has not changed sufficiently to warrant a request 116 for an incident occurrence data item 118, the process then proceeds to step 508, which depicts the security unit 102 waiting before re-initiating the process. The system program 204 will contain a clock routine in the configuration module 208 that will count cycles of the processor 200. After a sufficient number of processor cycles, a flag will be raised in the system program 204 that will cause the initiation of the process by means of the process returning to step 500.

If the location of the vehicle 100 has changed sufficiently to warrant a request 116 for an incident occurrence data item 118, the process next passes to step 510, which illustrates the security unit 102 sending a request 116 for an incident occurrence data item 118 to the incident data server 114. In the alternative embodiment herein depicted, the incident occurrence data item 118 will contain a suggested configuration of the security unit 102. This suggested configuration will typically be created by the incident server module 136 on the incident data server 114 and will typically be based on the relative frequency of incidents within a reasonable proximity to the location of the vehicle 100. The process then proceeds to step 512, which depicts the security unit 102 receiving a suggested configuration in the form of an incident occurrence data item 118 from the incident data server 114. The process then proceeds to step 514, which depicts the security unit 102 determining whether the security unit 102 is correctly configured. This is done by comparing the current configuration 216 of the security unit 102 to the configuration in the incident data item 118 in step 512. If the security unit 102 determines that the current configuration 216 is still appropriate, the process then proceeds to step 508, which depicts the security unit 102 waiting before re-initiating the process. The system program 204 will contain a clock routine in the configuration module 208 that will count cycles of the processor 200. After a sufficient number of processor cycles, a flag will be raised in the system program 204 that will cause the initiation of the process by means of the process returning to step 500. If the security unit 102 determines that the current configuration 216 is not appropriate, the process next passes to step 516, which depicts the security unit 102 altering its configuration. The security unit 102 may automatically alter its configuration or may seek user ratification before doing so, using the user I/O devices 232 to present the proposed revisions to the configuration and to accept user input as to whether to proceed with the alteration. The security unit 102 may also present to the user the actual incident occurrence statistics for the geographic area in which the vehicle is located, or may summarize them.

Although aspects of the present invention have been described with respect to a computer system executing software that directs the functions of the present invention, it should be understood that present invention may alternatively be implemented as a program product for use with a data processing system. Programs defining the functions of the present invention can be delivered to a data processing system via a variety of signal-bearing media, which include, without limitation, non-rewritable storage media (e.g., CD-ROM), rewritable storage media (e.g., a floppy diskette or hard disk drive), and communication media, such as digital and analog networks. It should be understood, therefore, that such signal-bearing media, when carrying or encoding computer readable instructions that direct the functions of the present invention, represent alternative embodiments of the present invention.

What is claimed is:

1. A method of configuring a security unit, comprising:
determining a location of a security unit;
comparing said location of said security unit to a geographic database of incident occurrence statistics for the location; and
responsive to said incident occurrence statistics, automatically configuring said security unit to respond to an external stimulus dependent upon the incident occurrence statistics wherein the security unit responds to an external stimulus in at least a first manner for a first level of incident occurrence and in a second manner for a second level of incident occurrence.

2. The method of claim 1, wherein the determining step further comprises determining said location of said security unit using a radio-frequency signal.

3. The method of claim 1, wherein said security unit further comprises a security unit installed in a vehicle.

4. The method of claim 1, wherein the determining step further comprises determining said location from a user input.

5. The method of claim 1, wherein the security unit further comprises a security unit attached to a vehicle and the configuring step further comprises configuring said security unit to adjust the sensitivity of sensors that detect one or more of the set of penetration of the vehicle's physical perimeter, breaking of glass, attempts to activate the engine of the vehicle, the presence of persons within a set distance from the vehicle, and the application of physical force to the vehicle's exterior.

6. The method of claim 1, wherein the comparing step further comprises sending to an incident data server said location and receiving an incident occurrence data item from said server.

7. The method of claim 1, wherein the configuring step further comprises seeking user acceptance of a new configuration.

8. The method of claim 1, wherein the security unit further comprises a security unit attached to a stationary structure and the configuring step further comprises configuring said security unit to adjust the sensitivity of sensors that detect one or more of the set of penetration of the structure's physical perimeter, breaking of glass, the presence of persons within a set distance from the structure, and the application of physical force to the structure's exterior.

9. A method of configuring a security unit, comprising:
sending a location of a security unit to a remote data processing system;
receiving an indication of a level of incident occurrences for the location; and
automatically configuring the security unit to respond to an external stimulus dependent upon the level of incident occurrences wherein the security unit responds to the external stimulus in at least a first manner for a first level of incident occurrences and in a second manner for a second level of incident occurrences.

10. The method of claim 9, further comprising determining the location of the security unit by a navigation unit in a vehicle with the security unit.

11. An apparatus for configuring a security unit, comprising:
means for determining a location of a security unit;
means for comparing said location of said security unit to a geographic database of incident occurrence statistics for the location; and
means for, responsive to said incident occurrence statistics, automatically configuring said security unit to respond to an external stimulus dependent upon the incident occurrence statistics wherein the security unit responds to an external stimulus in at least a first manner for a first level of incident occurrence and in a second manner for a second level of incident occurrence.

12. The apparatus of claim 11, wherein the means for determining further comprises means for determining said location of said security unit using a radio-frequency signal.

13. The apparatus of claim 11, wherein said security unit further comprises a security unit installed in a vehicle.

14. The apparatus of claim 11, wherein the means for determining further comprises means for determining said location from a user input.

15. The apparatus of claim 11, wherein the security unit further comprises a security unit attached to a vehicle and the means for configuring further comprises means for configuring said security unit to adjust the sensitivity of sensors that detect one or more of the set of penetration of the vehicle's physical perimeter, breaking of glass, attempts to activate the engine of the vehicle, the presence of persons within a set distance from the vehicle, and the application of physical force to the vehicle's exterior.

16. The apparatus of claim 11, wherein the means for comparing further comprises means for sending to an incident data server said location and receiving an incident occurrence data item from said server.

17. The apparatus of claim 11, wherein the means for configuring further comprises means for seeking user acceptance of a new configuration.

18. The apparatus of claim 11, wherein the security unit further comprises a security unit attached to a stationary structure and the means for configuring further comprises means for configuring said security unit to adjust the sensitivity of sensors that detect one or more of the set of penetration of the structure's physical perimeter, breaking of glass, the presence of persons within a set distance from the structure, and the application of physical force to the structure's exterior.

19. An apparatus for configuring a security unit, comprising:
means for sending a location of a security unit to a remote data processing system;
means for receiving an indication of a level of incident occurrences for the location; and
means for automatically configuring the security unit to respond to an external stimulus dependent upon the level of incident occurrences wherein the security unit responds to the external stimulus in at least a first manner for a first level of incident occurrences and in a second manner for a second level of incident occurrences.

20. The method of claim 19, further comprising determining the location of the security unit by a navigation unit in a vehicle with the security unit.

21. A computer program product in a computer usable medium for configuring a security unit, comprising:
instructions on the computer usable medium for determining a location of a security unit;
instructions on the computer usable medium for comparing said location of said security unit to a geographic database of incident occurrence statistics for the location; and
instructions on the computer usable medium for, responsive to said incident occurrence statistics, automatically configuring said security unit to respond to an external stimulus dependent upon the incident occurrence statistics wherein the security unit responds to an external stimulus in at least a first manner for a first level of incident occurrence and in a second manner for a second level of incident occurrence.

22. The computer program product of claim 21, wherein the instructions for determining further comprise instructions on the computer usable medium for determining said location of said security unit using a radio-frequency signal.

23. The computer program product of claim 21, wherein said security unit further comprises a security unit installed in a vehicle.

24. The computer program product of claim 21, wherein the instructions for determining further comprise instructions on the computer usable medium for determining said location from a user input.

25. The computer program product of claim 21, wherein the security unit further comprises a security unit attached to a vehicle and the instructions for configuring further comprise instructions for configuring said security unit to adjust the sensitivity of sensors that detect one or more of the set of penetration of the vehicle's physical perimeter, breaking of glass, attempts to activate the engine of the vehicle, the presence of persons within a set distance from the vehicle, and the application of physical force to the vehicle's exterior.

26. The computer program product of claim 21, wherein the instructions for comparing further comprise instructions on the computer usable medium for sending to an incident data server said location and receiving an incident occurrence data item from said server.

27. The computer program product of claim 21, wherein the instructions for configuring further comprise instructions on the computer usable medium for seeking user acceptance of a new configuration.

28. The computer program product of claim 21, wherein the security unit further comprises a security unit attached to a stationary structure and the instructions for configuring further comprise instructions for configuring said security unit to adjust the sensitivity of sensors that detect one or more of the set of penetration of the structure's physical perimeter, breaking of glass, the presence of persons within a set distance from the structure, and the application of physical force to the structure's exterior.

29. A computer program product in a computer usable medium for configuring a security unit, comprising:
instructions for sending a location of a security unit to a remote data processing system;
instructions for receiving an indication of a level of incident occurrences for the location; and
instructions for automatically configuring the security unit to respond to an external stimulus dependent upon the level of incident occurrences wherein the security unit responds to the external stimulus in at least a first manner for a first level of incident occurrences and in a second manner for a second level of incident occurrences.

30. The computer program product of claim 29, further comprising instructions for determining the location of the security unit by a navigation unit in a vehicle with the security unit.
